(19) United States
(12) Patent Application Publication
(10) Pub. No.: US 2019/0018357 A1
(43) Pub. Date: Jan. 17, 2019

(54) IMAGE FORMING SYSTEM, IMAGE FORMING APPARATUS, CONTROL APPARATUS, CONTROL METHOD, AND PROGRAM

(71) Applicant: Konica Minolta, Inc., Tokyo (JP)

(72) Inventor: Yoshikazu KURIBAYASHI, Okazaki-shi (JP)

(21) Appl. No.: 16/005,446

(22) Filed: Jun. 11, 2018

(30) Foreign Application Priority Data
Jul. 11, 2017 (JP) 2017-135404

(51) Int. Cl. G03G 15/00; B65H 29/12; B65H 43/00; B65H 37/04

(52) U.S. Cl. CPC G03G 15/6529; G03G 15/50; H04N 1/00888; B65H 43/00; B65H 37/04; B65H 29/12

(57) ABSTRACT

An image forming system includes: an image forming apparatus; and a post-processing apparatus that is connectable to the image forming apparatus and performs predetermined processing on a recording medium on which an image is formed by the image forming apparatus, wherein the image forming apparatus includes an image forming unit that forms and fixes an image on a recording medium, a hardware processor that controls a first parameter of the image forming unit, the first parameter relating to a first processable number of sheets, and a second parameter of the post-processing apparatus, the second parameter relating to a second processable number of sheets, and a communication interface, the post-processing apparatus operates in accordance with the second parameter, and the hardware processor changes the second parameter to cause the second processable number of sheets to decrease, when changing the first parameter to cause the first processable number of sheets to decrease.

The entire disclosure of Japanese patent Application No. 2017-135404, filed on Jul. 11, 2017, is incorporated herein by reference in its entirety.

### BACKGROUND

### Technological Field

The present disclosure relates to an image forming system, and more specifically relates to cooperation between an image forming apparatus and a post-processing apparatus.

### Description of the Related Art

Power consumption is large of an image forming apparatus adopting an electrophotographic system. For example, power consumption is large of a device such as a conveying roller that conveys a recording medium, a fixing apparatus that fixes a toner image on the recording medium, or the like.

In addition, as a demand for improvement in productivity (the processable number of recording media per unit time) of the image forming apparatus is increased, the motor used for the image forming apparatus tends to become larger or faster. For that reason, the power consumption of the image forming apparatus tends to increase year by year.

The maximum current that can be supplied by a commercial power supply is determined for each country.

The maximum current is, for example, 15 A in Japan and the United States, and 10 A in the European Union (EU). For that reason, the rated current of the image forming apparatus needs to be designed to be less than the rated current of the commercial power supply.

For the above problem, for example, JP 2012-053482 A discloses an image forming apparatus that “includes a current detection circuit that detects an input current from a commercial power supply to an apparatus, and when a current detected by the current detection circuit exceeds a predetermined value, limits a maximum current that can be supplied to a fixing device, and when a temperature of the fixing device falls below a predetermined temperature lower than a control target temperature in a state in which the maximum current that can be supplied to the fixing device is limited, increase a conveying interval between recording materials to be conveyed to the fixing device” (“see abstract”).

In recent years, the image forming apparatus is increasingly used together with a post-processing apparatus. As the productivity of the image forming apparatus increases, power consumption of the post-processing apparatus that operates in cooperation with the image forming apparatus also tends to increase. That is, power consumption tends to increase of an image forming system including the image forming apparatus and the post-processing apparatus.

On the other hand, however, consideration of the environment requires power saving of electric devices. Therefore, there is a need for a technology to achieve further power saving of the image forming system.

### SUMMARY

The present disclosure has been made to solve the above-described problem, and an object in an aspect is to provide a technique capable of suppressing power consumption of the image forming system.

To achieve the abovementioned object, according to an aspect of the present invention, an image forming system reflecting one aspect of the present invention comprises: an image forming apparatus; and a post-processing apparatus that is connectable to the image forming apparatus and performs predetermined processing on a recording medium on which an image is formed by the image forming apparatus, wherein the image forming apparatus includes an image forming unit that forms and fixes an image on a recording medium, a hardware processor that controls a first parameter of the image forming unit, the first parameter relating to a first processable number of sheets that is a number of sheets of the recording medium processable by the image forming unit per unit time, and a second parameter of the post-processing apparatus, the second parameter relating to a second processable number of sheets that is a number of sheets of the recording medium processable by the post-processing apparatus per the unit time, and a communication interface that transmits the second parameter to the post-processing apparatus, the post-processing apparatus operates in accordance with the second parameter received from the image forming apparatus, and the hardware processor changes the second parameter to cause the second processable number of sheets to decrease, when changing the first parameter to cause the first processable number of sheets to decrease.

### BRIEF DESCRIPTION OF THE DRAWINGS

The objects, advantages, aspects, and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing a configuration of an image forming system according to a first embodiment and an image forming system according to a related art;

FIG. 2 is a diagram for explaining productivity of an image forming system in a state in which power shortage does not occur;

FIG. 3 is a diagram showing a correlation between a processable number of sheets and power required by a fixing apparatus;

FIG. 4 is a flowchart for explaining processing of the image forming system according to the related art when power shortage occurs;

FIG. 5 is a diagram for explaining the processing of the image forming system according to the related art when power shortage occurs;

FIG. 6 is a diagram for explaining processing of the image forming system according to the first embodiment when power shortage occurs;

FIG. 7 is a diagram showing a correlation between a sheet conveying speed and power reduction in a post-processing apparatus 1;

FIG. 8 is a block diagram showing an electrical configuration of an image forming system;

FIG. 9 is a diagram showing an example of the data structure of a correlation table;

FIG. 10 is a side view showing a configuration of the post-processing apparatus 1;

FIG. 11 is a flowchart showing printing processing of an image forming apparatus according to the first embodiment;

FIG. 12 is a diagram for comparing the image forming system according to the first embodiment with the image forming system according to the related art;

FIG. 13 is a diagram for explaining a configuration of an image forming system according to a second embodiment;

FIG. 14 is a diagram showing an example of the data structure of a correlation table;

FIG. 15 is a diagram for explaining a configuration of an image forming system according to a third embodiment; and

FIG. 16 is a diagram showing an example of the data structure of a low-temperature correlation table.

### DETAILED DESCRIPTION OF EMBODIMENTS

Hereinafter, one or more embodiments of this technical idea will be described in detail with reference to the drawings. However, the scope of the invention is not limited to the disclosed embodiments. In the following description, the same components are denoted by the same reference numerals. The names and functions thereof are also the same. Therefore, detailed description thereof will not be repeated. Embodiments and modifications described below may be selectively combined as appropriate.

### First Embodiment

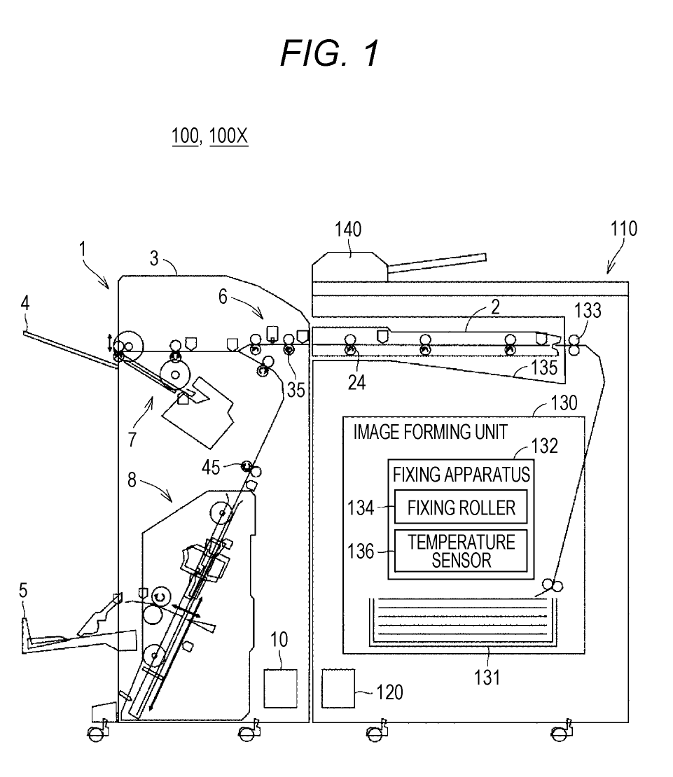

FIG. 1 is a diagram showing a configuration of an image forming system 100 according to a first embodiment and an image forming system 100X according to a related art. Hereinafter, a control overview of the image forming system 100 will be described while contrasting with the image forming system 100X.

(Control Overview)

First, to describe the control overview of the image forming system 100, an outline will be described of a hardware configuration of the image forming system 100. The detailed hardware configuration of the image forming system 100 will be described later. Note that, the hardware configuration of the image forming system 100 and the hardware configuration of the image forming system 100X are the same as each other. For that reason, the description will not be repeated of the hardware configuration of the image forming system 100X.

The image forming system 100 includes a post-processing apparatus 1 and an image forming apparatus 110. The post-processing apparatus 1 is connectable to the image forming apparatus 110 and performs predetermined post-processing (stapling processing or the like) on a sheet (recording medium) on which an image is formed by the image forming apparatus 110. The post-processing apparatus 1 receives power supply from the image forming apparatus 110 and is driven. Note that, in another aspect, the post-processing apparatus 1 may be configured to directly receive power supply from a commercial power supply.

The image forming apparatus 110 includes an image forming unit 130 that forms and fixes an image on a sheet. The image forming unit 130 includes a fixing apparatus 132 that fixes the image on the sheet. The sheet on which the image is formed and fixed by the image forming unit 130 is conveyed on a conveying path. The sheet is conveyed to a horizontal conveying device 2 of the post-processing apparatus 1 by the main body ejection roller 133. The sheet is conveyed to a processing device main body 3 of the post-processing apparatus 1 by a final roller 24. A sheet conveying speed in the image forming apparatus 110 and a sheet conveying speed in the horizontal conveying device 2 are set to the same speed.

After the conveying timing is adjusted by the registration roller 35, the sheet conveyed to the processing device main body 3 is further conveyed on the conveying path inside the post-processing apparatus 1. In an aspect, the sheet is conveyed to a saddle stitching processing device 8 by a loading roller 45.

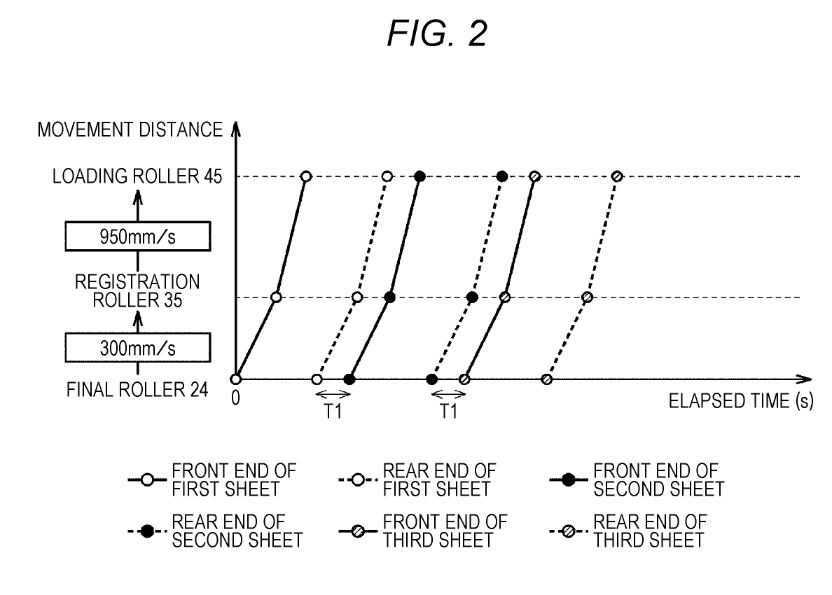

FIG. 2 is a diagram for explaining productivity (processable number of sheets) of the image forming system 100 in a state in which power shortage does not occur. The productivity of the image forming system 100 mainly depends on the sheet conveying speed and an interval between the sheets (hereinafter also referred to as “inter-sheet distance”). Specifically, the productivity of the image forming system 100 improves as the sheet conveying speed increases and the inter-sheet distance decreases.

In FIG. 2, the horizontal axis represents an elapsed time after the sheet passes through the final roller 24, and the vertical axis represents a movement distance after the sheet passes through the final roller 24. In the state in which power shortage does not occur, the horizontal conveying device 2 of the image forming apparatus 110 and the post-processing apparatus 1 conveys the sheet at 300 mm/s, and the processing device main body 3 of the post-processing apparatus 1 conveys the sheet at 950 mm/s. The reason why the conveying speed of the post-processing apparatus 1 (the processing device main body 3) is higher than the conveying speed of the image forming apparatus 110 is to complete post-processing of the first sheet in the post-processing apparatus 1 before the second sheet reaches a post-processing position (for example, the registration roller 35).

In the state in which power shortage does not occur, the front end of the second sheet passes through the final roller 24 after a lapse of time T1 after the rear end of the first sheet passes through the final roller 24. That is, an inter-sheet distance D1 in the image forming apparatus 110 in the state in which power shortage does not occur is a value obtained by multiplying the time T1 by 300 mm/s. As an example, the processable number of sheets (productivity) of the image forming apparatus 110 in the state in which power shortage does not occur is set to 60 Pages Per Minute (PPM).

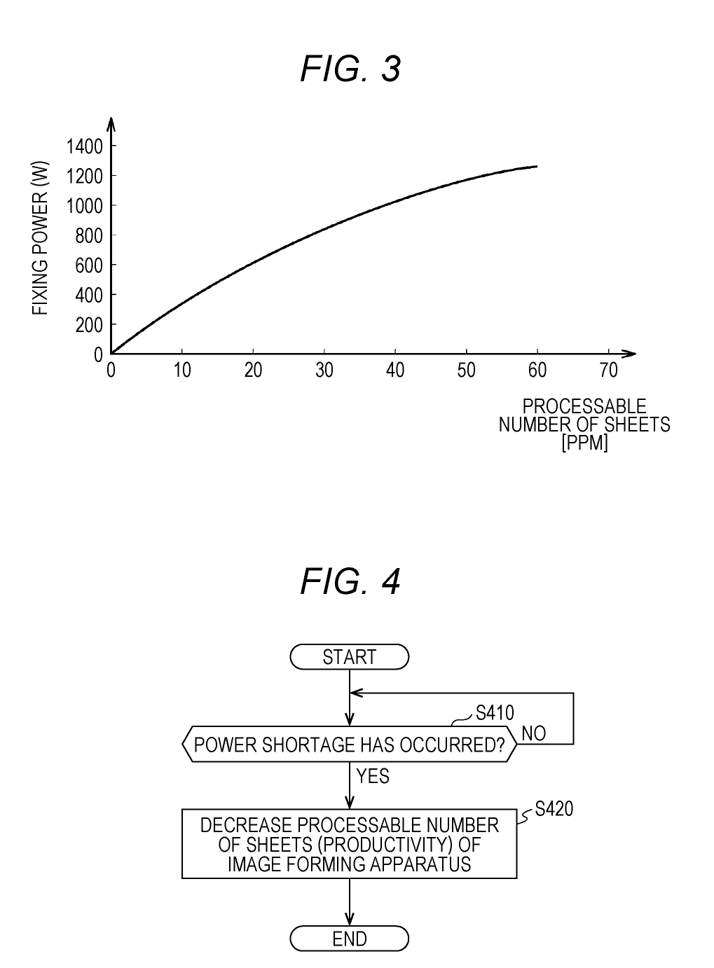

FIG. 3 is a diagram showing a correlation between the processable number of sheets and the power required by the fixing apparatus 132. Referring to FIG. 3, as the processable number of sheets increases, the power required by the fixing apparatus 132 (hereinafter also referred to as “fixing power”) increases. This is because as the processable number of sheets increases, an amount of heat taken away by the sheet from the fixing apparatus 132 per unit time increases, whereas the fixing apparatus 132 needs to apply a predetermined amount of heat to the sheet to fix the image on the sheet.

Next, differences will be described between the processing of the image forming system 100X according to the related art and the processing of the image forming system 100 according to the first embodiment, when the power shortage occurs.

<Control Overview of Image Forming System 100X According to Related Art>

FIG. 4 is a flowchart for explaining the processing of the image forming system 100X according to the related art when power shortage occurs. In the following description, the configuration of the image forming system 100X will be described with the reference symbol X attached. For example, an image forming apparatus 110X is included in the image forming system 100X.

In step S410, the image forming apparatus 110X determines whether or not power shortage has occurred in the image forming system 100X. In a case where it is determined that power shortage has occurred (YES in step S410), the image forming apparatus 110X executes the processing of step S420. For example, when a post-processing function of a post-processing apparatus 1X and a scanner function of the image forming apparatus 110X are simultaneously used, power shortage occurs in the image forming system 100X.

In step S420, the image forming apparatus 110X decreases the processable number of sheets (productivity) and lowers the fixing power, thereby resolving power shortage of the image forming system 100X.

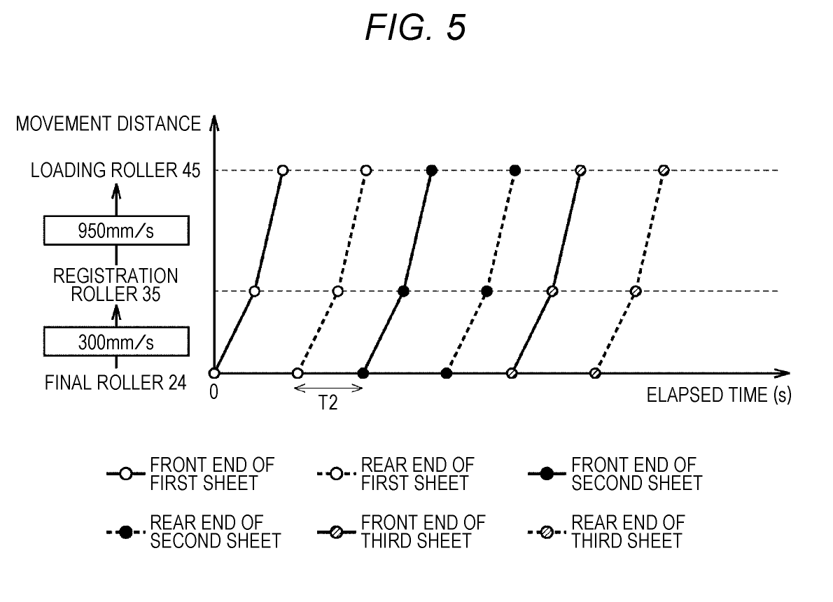

More specifically, as shown in FIG. 5, the image forming apparatus 110X decreases the processable number of sheets by increasing the inter-sheet distance. That is, the image forming apparatus 110X sets time T2 to be longer than the above time T1, the time T2 being time after the rear end of the first sheet passes through the final roller 24 until the front end of the second sheet passes through the final roller 24. At this time, the image forming system 100X does not change the sheet conveying speed in the post-processing apparatus 1X.

<Control Overview of Image Forming System 100 According to Embodiment>

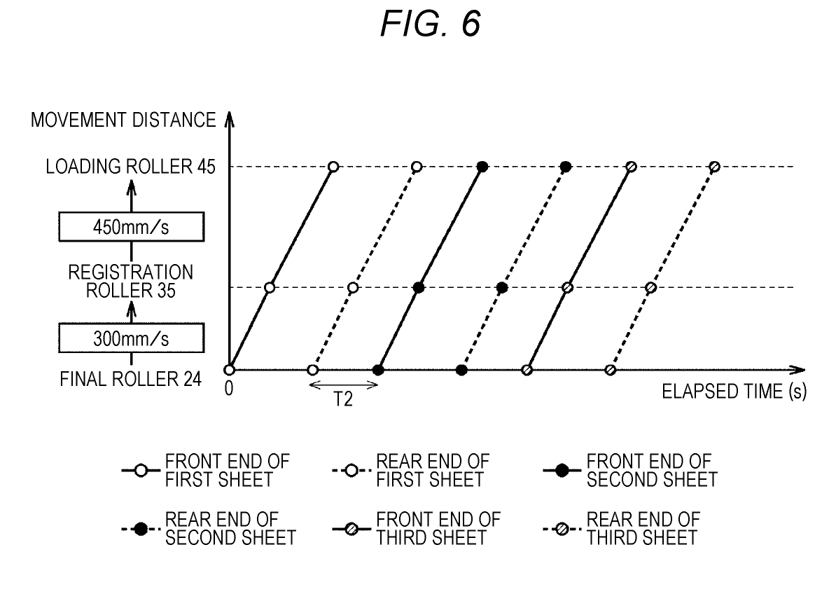

FIG. 6 is a diagram for explaining the processing of the image forming system 100 according to the first embodiment when power shortage occurs. In a case where power shortage occurs, the image forming apparatus 110 decreases the processable number of sheets of the image forming apparatus 110 to lower the fixing power, similarly to the image forming apparatus 110X. Further, the image forming apparatus 110 lowers the sheet conveying speed in the post-processing apparatus 1. In the example shown in FIG. 6, the conveying speed of the post-processing apparatus 1 is changed from 950 mm/s to 450 mm/s.

This is because due to the decrease in the processable number of sheets in the image forming apparatus 110, even when the sheet conveying speed in the post-processing apparatus 1 is lowered, the post-processing apparatus 1 can complete post-processing of the first sheet before the second sheet reaches the post-processing position. Thus, the image forming system 100 according to the first embodiment can suppress power consumption in the post-processing apparatus 1.

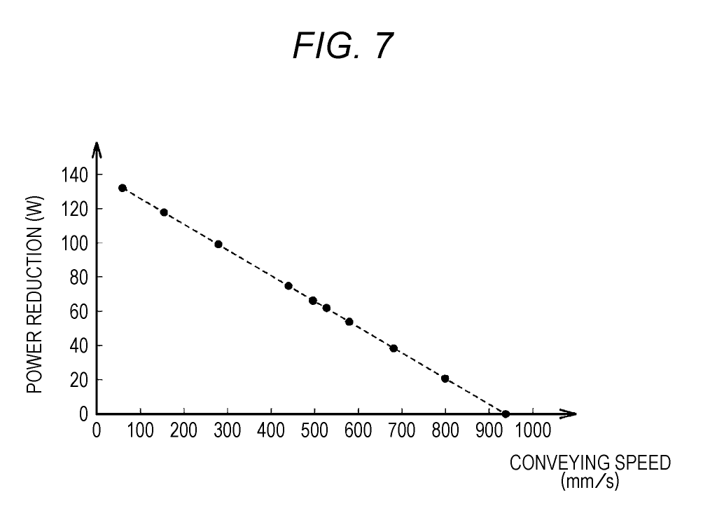

FIG. 7 is a diagram showing a correlation between the sheet conveying speed in the post-processing apparatus 1 and power reduction. The power reduction is power consumption of the post-processing apparatus 1 that can be reduced when the sheet conveying speed in the post-processing apparatus 1 is lowered. In the example shown in FIG. 7, the power reduction is a reduction amount of the power consumption with respect to a decrease of the conveying speed, with reference to the sheet conveying speed (950 mm/s) in the post-processing apparatus 1 when the power shortage does not occur.

As shown in FIG. 7, the lower the sheet conveying speed in the post-processing apparatus 1, the greater the power reduction. For example, by changing the conveying speed of the post-processing apparatus 1 from 950 mm/s to 450 mm/s, power reduction occurs of about 60 W. A specific configuration and control of the image forming system 100 will be described below.

(Configuration of Image Forming Apparatus 110)

Referring back to FIG. 1, the image forming apparatus 110 includes a control apparatus 120, the image forming unit 130, and a scanner 140. The control apparatus 120 controls operation of each device of the image forming apparatus 110. A more specific configuration of the control apparatus 120 will be described later.

The image forming unit 130 forms an image on a sheet in accordance with an electrophotographic system. The image forming unit 130 feeds the sheets stored in a sheet cassette 131, for example, to the conveying path one by one, and forms an image on the sheets sequentially conveyed. The image forming unit 130 fixes the formed image on the sheet by a fixing roller 134 of the fixing apparatus 132. The fixing apparatus 132 further includes a temperature sensor 136 that measures a temperature of the fixing roller 134.

The sheet on which the image is formed and fixed is fed from the image forming apparatus 110 toward an output tray 135 provided at the upper part of the image forming apparatus 110 by a main body ejection roller 133.

The scanner 140 reads a document arranged at a predetermined position of the scanner 140 with an imaging apparatus or the like, and outputs its image data. The scanner 140 reads the document while conveying the document with, for example, an Auto Document Feeder (ADF). In another aspect, the scanner 140 scans a document placed on a document table provided on the upper surface of the image forming apparatus 110 with a line sensor, and reads the document.

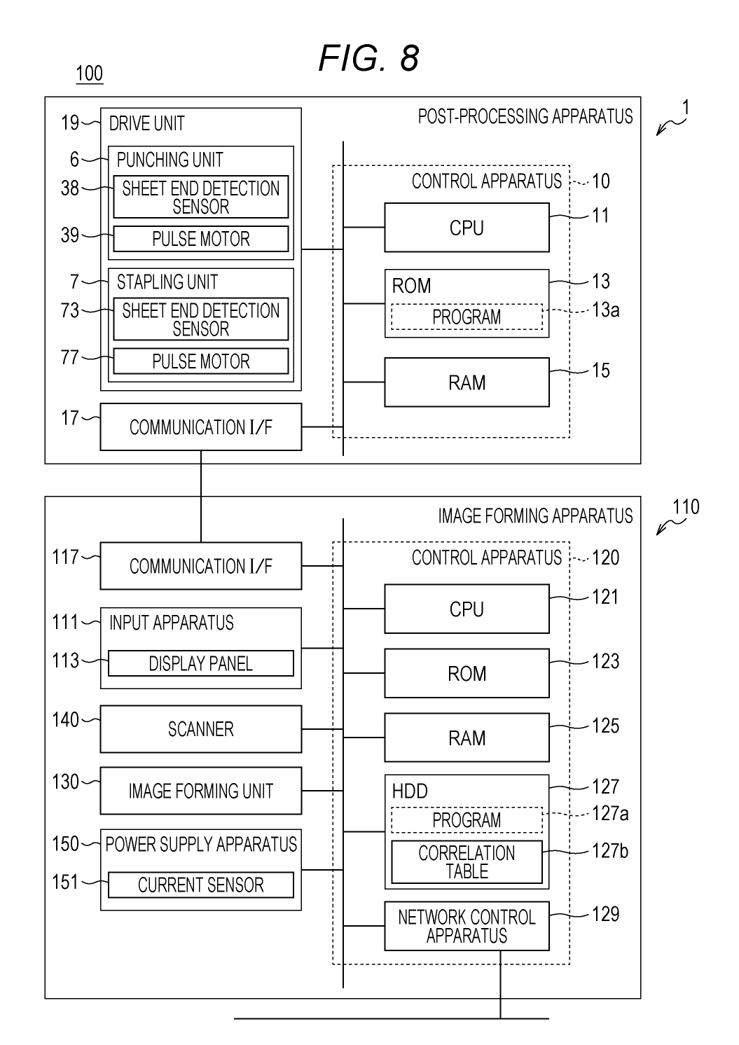

FIG. 8 is a block diagram showing an electrical configuration of the image forming system 100. Referring to FIG. 8, the image forming apparatus 110 further includes an input apparatus 111, a communication interface (I/F) 117, and a power supply apparatus 150.

The control apparatus 120 includes a Central Processing Unit (CPU) 121, Read Only Memory (ROM) 123, Random Access Memory (RAM) 125, a Hard Disk Drive (HDD) 127, and a network control apparatus 129. The control apparatus 120 is connected to a system bus to which the input apparatus 111, the communication I/F 117, the image forming unit 130, and the scanner 140 are connected. Thus, the control apparatus 120 and each device of the image forming apparatus 110 are connected together so that signals can be transmitted and received.

The HDD 127 stores job data sent from the outside via the network control apparatus 129, image data read by the scanner 140, and the like. In addition, the HDD 127 stores setting information of the image forming apparatus 110, a program 127a for performing various operations of the image forming apparatus 110, and a correlation table 127b. In addition, the HDD 127 stores a plurality of jobs transmitted from one or more client terminals.

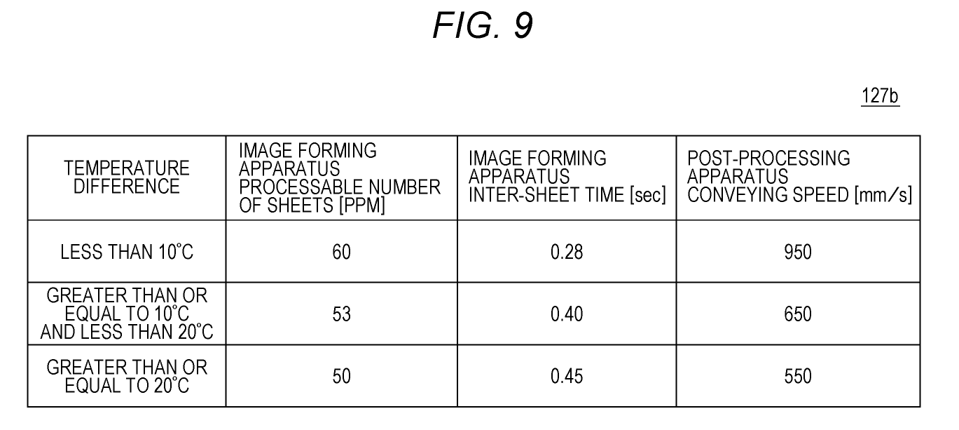

FIG. 9 is a diagram showing an example of the data structure of the correlation table 127b. The correlation table 127b holds a temperature difference, the processable number of sheets (productivity) in the image forming apparatus 110, an inter-sheet time in the image forming apparatus 110, and the sheet conveying speed in the post-processing apparatus 1 in association with each other. The temperature difference is a value obtained by subtracting the temperature Ts of the fixing roller 134 measured by the temperature sensor 136 from a preset target temperature Ta. The inter-sheet time is a value obtained by dividing the inter-sheet distance by the sheet conveying speed in the image forming apparatus 110. That is, it is a required time after the rear end of the first sheet passes through a predetermined position of the image forming apparatus 110 until the rear end of the second sheet passes through the predetermined position. In a case where the sheet conveying speed in the image forming apparatus 110 is a fixed value, the inter-sheet time is proportional to the inter-sheet distance. For that reason, in an aspect, the correlation table 127b represents a correspondence between the inter-sheet distance in the image forming apparatus 110 and the sheet conveying speed in the post-processing apparatus 1.

Referring back to FIG. 8, the network control apparatus 129 is configured by combining hardware such as a Network Interface Card (NIC) and software performing communication using a predetermined communication protocol. The network control apparatus 129 connects the image forming apparatus 110 to an external network such as a Local Area Network (LAN). Thus, the image forming apparatus 110 can communicate with an external apparatus connected to the external network. The image forming apparatus 110 receives a print job via the external network, and transmits the image data read by the scanner 140 to an external apparatus. Note that, the network control apparatus 129 may be configured to be connectable to the external network by wireless communication.

The CPU 121 reads and executes the program 127a stored in the ROM 123, the RAM 125, the HDD 127, or the like, thereby controlling operation of each device of the image forming apparatus 110. The CPU 121 executes predetermined processing in accordance with an operation signal input from the input apparatus 111 or an operation command input from an external apparatus.

The ROM 123 is, for example, a flash ROM (Flash Memory). The ROM 123 stores operation settings and the like of the image forming apparatus 110. The ROM 123 may be a non-rewritable one.

The RAM 125 functions as a main memory of the CPU 121. The RAM 125 temporarily stores data necessary for the CPU 121 to execute the program 127a.

The input apparatus 111 is arranged on a casing of the image forming apparatus 110 to be operable by a user. The input apparatus 111 includes a plurality of operation buttons and a display panel 113. The display panel 113 is, for example, a Liquid Crystal Display (LCD) including a touch panel.

The display panel 113 is controlled by the CPU 121 to perform display. When the operation button and the display panel 113 are operated by the user, the input apparatus 111 transmits an operation signal or a predetermined command corresponding to the operation to the CPU 121.

The communication I/F 117 is configured to be connectable to a communication I/F 17 provided in the post-processing apparatus 1, for example, via a cable, a connector, or the like. The communication I/F 117 is configured by combining hardware, and software for communicating with the post-processing apparatus 1 using a predetermined communication protocol. When the communication I/F 117 is connected to the communication I/F 17, the image forming apparatus 110 operates in conjunction with the post-processing apparatus 1.

The power supply apparatus 150 supplies power to various devices constituting the image forming apparatus 110 and the post-processing apparatus 1. The power supply apparatus 150 includes a current sensor 151. The current sensor 151 measures a current value flowing through the power supply apparatus and outputs a measurement result to the control apparatus 120 via the system bus.

The image forming apparatus 110 described above is, for example, a Multi Function Peripheral (MFP) having a scanner function, a copying function, a printer function, a facsimile function, and the like. The copying function is a function of printing a read document on a sheet (recording medium). The printer function is a function of printing on a sheet based on a print instruction received from an external apparatus via the network control apparatus 129. The facsimile function is a function of receiving facsimile data from an external facsimile apparatus or the like and storing the data in the HDD 127 or the like.

(Configuration of Post-Processing Apparatus 1)

Referring back to FIG. 1, the post-processing apparatus 1 includes the horizontal conveying device 2, the processing device main body 3, a sheet tray 4, a booklet tray 5, and a control apparatus 10. The processing device main body 3 includes a punching processing device 6 that performs punching processing, a stapling processing device 7 that performs stapling processing of side stitching, and a saddle stitching processing device 8 that performs saddle stitching processing.

The horizontal conveying device 2 introduces a sheet fed from the main body ejection roller 133 of the image forming apparatus 110 into the post-processing apparatus 1, and conveys the sheet to the processing device main body 3 of the subsequent stage. The processing device main body 3 performs post-processing such as punching processing, sorting processing, stapling processing, folding processing on a sheet conveyed, and ejects the sheet to the sheet tray 4 or the booklet tray 5. The punching processing is, for example, processing of making holes at predetermined positions on each sheet. The sorting processing is, for example, processing of collecting a plurality of sheets for each of copies and ejects the copies to different positions or different trays so that the copies can be easily distinguished. The stapling processing is processing of collectively binding a plurality of sheets with staples. The folding processing is processing of folding a sheet into two or three. The sheet subjected to post-processing by the stapling processing device 7 is ejected to the sheet tray 4. The sheet subjected to post-processing by the saddle stitching processing device 8 is ejected to the booklet tray 5.

The control apparatus 10 controls operation of each device of the post-processing apparatus 1. Details of the control apparatus 10 will be described later.

Referring to FIG. 8, the post-processing apparatus 1 further includes the communication I/F 17 and a drive unit 19. The control apparatus 10 includes a CPU 11, ROM 13, and RAM 15. The control apparatus 10, the communication I/F 17, and the drive unit 19 are connected to the system bus and can communicate with each other. Note that, various sensors and the like described later are also connected to the system bus and can communicate with the control apparatus 10.

The ROM 13 is, for example, a flash ROM. The ROM 13 stores operation settings of the post-processing apparatus 1 and a program 13a for the post-processing apparatus 1 to perform various operations.

The RAM 15 functions as a main memory of the CPU 11. The RAM 15 temporarily stores data necessary for the CPU 11 to execute the program 13a.

The CPU 11 executes the program 13a stored in the ROM 13, thereby controlling various operations of the post-processing apparatus 1. The CPU 11 performs predetermined processing, thereby performing reading of data from the ROM 13 and writing of data to the ROM 13. Note that, the ROM 13 may be a non-rewritable one.

The drive unit 19 includes a motor that operates each device of the post-processing apparatus 1, a sensor that acquires information for its operation, and the like. Specifically, for example, the drive unit 19 includes a punching unit 37, a stapling unit 72, other drive motors, and the like. The drive unit 19 operates on the basis of an instruction from the control apparatus 10 and drives the horizontal conveying device 2, the processing device main body 3, and the like, and performs conveying of the sheet and post-processing.

The punching unit 37 is driven by a pulse motor 39. The punching unit 37 can move in a direction orthogonal to a conveying direction of a sheet of the punching processing device 6. The punching unit 37 includes a sheet end detection sensor 38. The sheet end detection sensor 38 detects an end of a sheet conveyed to the punching processing device 6. That is, in a case where the punching unit 37 is moving in the direction orthogonal to the conveying direction of the sheet, when the end of the sheet comes close to the sheet end detection sensor 38, the sheet is detected by the sheet end detection sensor 38. Then, the control apparatus 10 acquires end information corresponding to a position of the end of the sheet on the basis of a position of the punching unit 37 at that time.

The stapling unit 72 is driven by a pulse motor 77. The stapling unit 72 can move in the direction orthogonal to the conveying direction of the sheet conveyed to the stapling processing device 7. The stapling unit 72 includes a sheet end detection sensor 73. The sheet end detection sensor 73 detects an end of a sheet positioned in a processing tray 70. That is, in a case where the stapling unit 72 is moving in the direction orthogonal to the conveying direction of the sheet, when the end of the sheet comes close to the sheet end detection sensor 73, the sheet is detected by the sheet end detection sensor 73. Then, the control apparatus 10 acquires end information corresponding to a position of the end of the sheet on the basis of a position of the stapling unit 72 at that time.

The communication I/F 17 is connectable to the communication I/F 117 of the image forming apparatus 110. The communication I/F 17 is configured by combining hardware connectable to cables and connectors used for connecting to the communication I/F 117, and software for communicating with the image forming apparatus 110 using a predetermined communication protocol.

In a state in which the communication I/F 17 is connected to the communication I/F 117, the control apparatus 10 can communicate with the control apparatus 120 of the image forming apparatus 110. The control apparatus 120 transmits information indicating an operation state of the image forming apparatus 110 to the control apparatus 10. The information indicating the operation state includes post-processing information and sheet information, for example. The post-processing information is information on post-processing to be executed. The sheet information includes information such as the thickness of the sheet, the type of the sheet, and the number of sheets to be processed for each post-processing.

The control apparatus 10 receives information transmitted from the control apparatus 120, drives the drive unit 19 depending on the information, and controls the operation of each device of the post-processing apparatus 1. In addition, the control apparatus 10 transmits information on an operation state of the post-processing apparatus 1 and the like to the control apparatus 120. Thus, the image forming apparatus 110 and the post-processing apparatus 1 operate in conjunction with each other. For example, to cause the post-processing apparatus 1 to appropriately perform post-processing, the control apparatus 120 changes the image formation timing of a plurality of sheets, to perform control to convey the sheets at appropriate intervals to the post-processing apparatus 1.

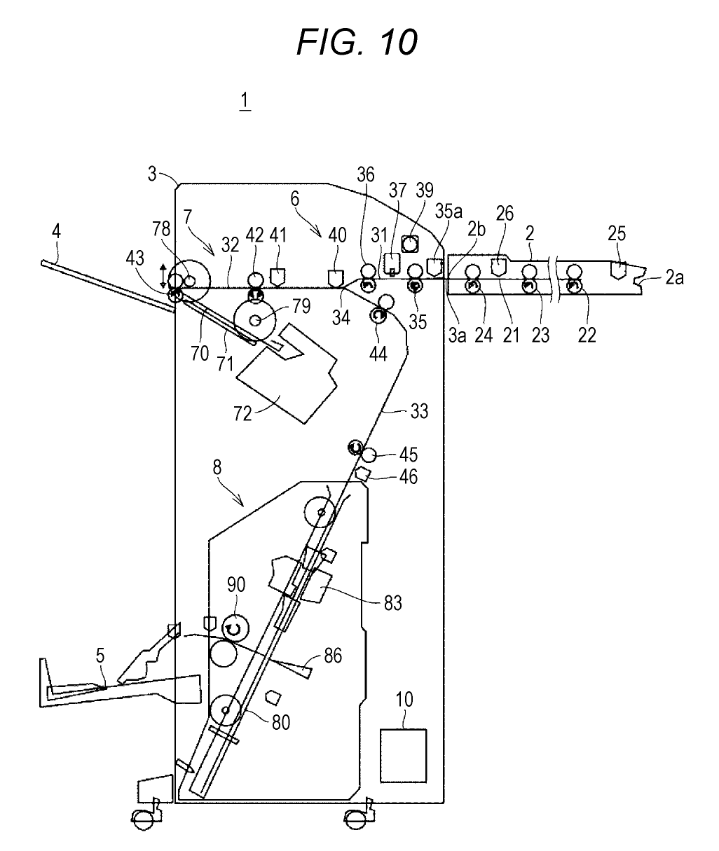

Note that, the control apparatus 10 can operate on the basis of an instruction input by the input apparatus 111 of the image forming apparatus 110 or an instruction sent from an external device connected to the image forming apparatus 110. Next, a more detailed configuration of the post-processing apparatus 1 will be described with reference to FIG. 10.

FIG. 10 is a side view showing the configuration of the post-processing apparatus 1. The horizontal conveying device 2 includes a horizontal conveying path 21 that is a sheet conveying path, three conveying rollers 22, 23, and 24, and sensors 25 and 26 that detect the sheets.

The horizontal conveying path 21 is arranged so as to convey the sheet substantially horizontally from the loading port 2a to the ejection port 2b. The three conveying rollers 22, 23, and 24 are provided along the horizontal conveying path 21 in order from the upstream side (loading port 2a side) of the horizontal conveying path 21. Among the three conveying rollers 22, 23, and 24, the conveying roller 24 positioned at the most downstream side is also referred to as the final roller 24. The sheet ejected from the main body ejection roller 133 of the image forming apparatus 110 is introduced into the horizontal conveying device 2 from the loading port 2a. The introduced sheet is sent to the processing device main body 3 by the conveying rollers 22, 23, and 24.

The processing device main body 3 includes a first conveying path 31, a second conveying path 32, and a third conveying path 33 as sheet conveying paths. The first conveying path 31 is arranged so as to connect the loading port 3a of the sheet provided at the upper part of the processing device main body 3 to the start point of the second conveying path 32 substantially horizontally.

The second conveying path 32 is arranged so as to connect the end point of the first conveying path 31 to the sheet tray 4 substantially horizontally. In the second conveying path 32, the vicinity of the portion (upstream side) connected to the first conveying path 31 is a switchback point 34. The third conveying path 33 is arranged so as to convey the sheet from the end point of the first conveying path 31 to the saddle stitching processing device 8 arranged at the lower part of the processing device main body 3. That is, the third conveying path 33 is a sheet conveying path from the switchback point 34 to the lower part of the processing device main body 3.

In the first conveying path 31, from the upstream side thereof, a registration sensor 35a, the registration roller 35, an intermediate roller 36, and the punching unit 37 are provided. The registration sensor 35a detects the sheet conveyed to the first conveying path 31. The registration roller 35 adjusts the conveying timing of the sheet conveyed, and starts conveying again at a predetermined timing. The punching unit 37 makes a hole (performs punching processing) in a predetermined position of the sheet conveyed. The intermediate roller 36 conveys the sheet to the second conveying path 32.

The switchback point 34 is provided with a switchback sensor 40. In addition to the switchback sensor 40, an accommodation sensor 41 and an accommodation roller 42 are provided in the second conveying path 32, from the upstream side thereof. On the downstream end of the second conveying path 32, that is, on the sheet tray 4 side, an ejection roller 43 is provided. The switchback sensor 40 and the accommodation sensor 41 each detect the presence or absence of the sheet conveyed. The accommodation roller 42 is capable of normal rotation and reverse rotation, and can convey the sheet to the sheet tray 4 or convey the sheet in the reverse direction. When the accommodation roller 42 is rotated in the reverse direction, the sheet in the second conveying path 32 is conveyed to the third conveying path 33. The ejection roller 43 controls ejection/non-ejection of the sheet by bringing the pair of rollers into contact with or away from each other. In an aspect, when the position of the front end of the sheet reaches a position separated by a predetermined distance (for example, 10 mm) to the upstream side from the ejection roller 43 (ejection port), the control apparatus 10 reduces the sheet conveying speed. Thus, the post-processing apparatus 1 inhibits the sheet from jumping out vigorously.

The stapling processing device 7 is arranged in the vicinity of the second conveying path 32. The stapling processing device 7 includes the processing tray 70 whose upper end is inclined so as to come close to the ejection roller 43, an accommodation belt 71 arranged along the processing tray 70, and the stapling unit 72 positioned at the lower end of the processing tray 70. Above the vicinity of the upper end side of the processing tray 70, an accommodation upper paddle 78 is arranged. Above the vicinity of the lower end of the processing tray 70, an accommodation lower paddle 79 is provided.

In the third conveying path 33, a switchback roller 44, the loading roller 45, and a saddle loading sensor 46 are provided, from the upstream side (switchback point 34 side). In the third conveying path 33, the portion on the downstream side from the saddle loading sensor 46 is positioned inside the saddle stitching processing device 8. In an aspect, when the accommodation roller 42 rotates in the reverse direction, the sheet positioned in the second conveying path 32 is introduced into the third conveying path 33. The switchback roller 44 conveys the sheet along the third conveying path 33. The loading roller 45 conveys the sheet to the saddle stitching processing device 8. The saddle loading sensor 46 detects the sheet conveyed to the saddle stitching processing device 8. In an aspect, when the rear end of the sheet reaches a position separated by a predetermined distance (for example, 10 mm) to the upstream side from the loading roller 45, the control apparatus 10 reduces the sheet conveying speed. Thus, the post-processing apparatus 1 inhibits the sheet from being loaded into the saddle vigorously.

In the saddle stitching processing device 8, a saddle stitching tray 80 is arranged along the third conveying path 33. In the vicinity of the saddle stitching tray 80, a saddle stitching stapler 83, a folding knife 86, and the like are provided. In the saddle stitching processing device 8, a pair of folding rollers 90 is arranged so as to face the folding knife 86.

(Post-Processing)

The post-processing in the post-processing apparatus 1 is performed on the basis of control by the control apparatus 10. The control apparatus 10 executes specified post-processing as appropriate in accordance with an instruction input content from the user via the input apparatus 111 or the like of the image forming apparatus 110.

The post-processing apparatus 1 sequentially conveys sheets to be fed one by one from the image forming apparatus 110, and stacks the sheets on the processing tray 70 or the saddle stitching tray 80. During conveying the sheet, the post-processing apparatus 1 performs punching processing by the punching processing device 6 in accordance with an instruction input content from the user. The stapling processing device 7 or the saddle stitching processing device 8 performs post-processing for each bundle of a plurality of sheets stacked on the processing trays 70 and 80, and then ejects the sheet.

The punching processing device 6 punches the sheet by the punching unit 37 at the post-processing position or a position in the vicinity thereof for each sheet conveyed. The punched sheet is conveyed to the processing trays 70 and 80 or ejected from the processing device main body 3 depending on other post-processing details.

The stapling processing device 7 stacks the conveyed sheets one by one on the processing tray 70, and staples a predetermined number of sheets by the stapling unit 72. More specifically, when the rear end of the sheet passes through the accommodation roller 42, the stapling processing device 7 drives the accommodation upper paddle 78, the accommodation lower paddle 79, and the accommodation belt 71 to stack the sheet on the processing tray 70. The stapled sheet is ejected onto the sheet tray 4. Next, specific processing will be described of the image forming system 100 according to the first embodiment.

(Control Structure)

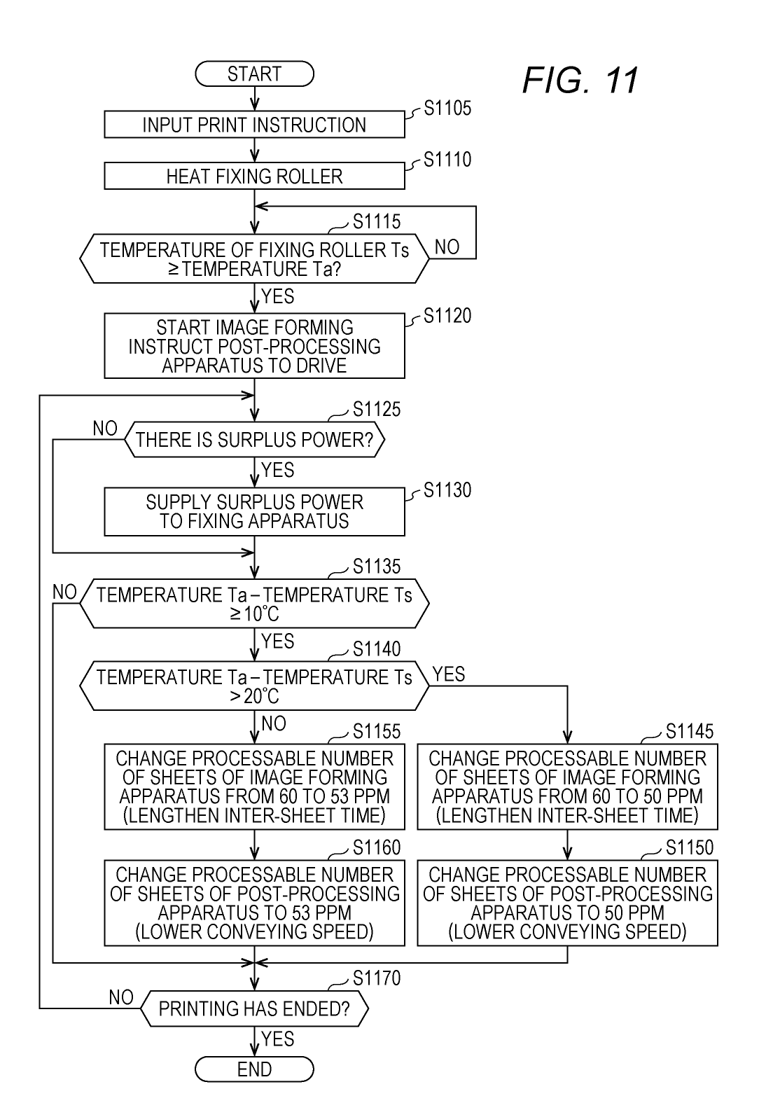

FIG. 11 is a flowchart showing printing processing of the image forming apparatus 110 according to the first embodiment. The CPU 121 of the control apparatus 120 reads and executes the program 127a, whereby each processing step shown in FIG. 11 is achieved.

In step S1105, the CPU 121 receives an input of a print instruction (print job) via the input apparatus 111 or the network control apparatus 129.

In step S1110, the CPU 121 starts heating the fixing roller 134 in response to input of the print instruction.

In step S1115, the CPU 121 determines whether or not the temperature Ts of the fixing roller 134 measured by the temperature sensor 136 is higher than or equal to the target temperature Ta. In a case where it is determined that the temperature Ts is higher than or equal to the target temperature Ta (YES in step S1115), the CPU 121 executes the processing of step S1120.

In step S1120, the CPU 121 starts conveying of the sheet by the image forming unit 130 and image forming operation. The CPU 121 further transmits a drive instruction to the post-processing apparatus 1. The control apparatus 10 of the post-processing apparatus 1 starts driving of various motors included in the drive unit 19 in response to reception of the drive instruction.

In step S1125, the CPU 121 determines whether or not there is surplus power. More specifically, the CPU 121 calculates power consumption Pe consumed by the image forming system 100 (the image forming apparatus 110 and the post-processing apparatus 1) on the basis of the current value flowing through the power supply apparatus 150 measured by the current sensor 151. The CPU 121 further calculates surplus power Pf by subtracting the power consumption Pe from predetermined setting power consumption Pt. In a case where the surplus power Pf is greater than 0 (YES in step S1125), the CPU 121 supplies the surplus power Pf to the fixing apparatus 132 (step S1130). On the other hand, in a case where the surplus power Pf is less than or equal to 0 (NO in step S1125), the CPU 121 executes the processing of step S1135.

In step S1135, the CPU 121 determines whether or not the temperature difference obtained by subtracting the temperature Ts of the fixing roller 134 from the target temperature Ta is greater than or equal to 10° C. In a case where it is determined that the temperature difference is greater than or equal to 10° C., the CPU 121 executes the processing of step S1140. Otherwise (NO in step S1135), the CPU 121 executes the processing of step S1170.

In step S1140, the CPU 121 determines whether or not the temperature difference obtained by subtracting the temperature Ts of the fixing roller 134 from the target temperature Ta is greater than 20° C. In a case where it is determined that the temperature difference is greater than 20° C., the CPU 121 executes the processing of step S1145. Otherwise (NO in step S1145), the CPU 121 executes the processing of step S1155.

In step S1145, the CPU 121 refers to the correlation table 127b stored in the HDD 127 and reduces the processable number of sheets of the image forming apparatus 110 from 60 PPM to 50 PPM so that the processable number of sheets corresponds to the temperature difference calculated in step S1140. More specifically, the CPU 121 refers to the correlation table 127b and changes the inter-sheet time from 0.28 s to 0.40 s. As a result, the registration roller (not shown) in the image forming unit 130 allows the front end of the second sheet to pass through after a lapse of a set inter-sheet time after the rear end of the first sheet passes through. That is, the CPU 121 changes the inter-sheet distance by changing the inter-sheet time. Thus, the inter-sheet distance becomes longer, and the processable number of sheets of the image forming apparatus 110 decreases.

When the processable number of sheets of the image forming apparatus 110 decreases, an amount of heat taken away by the sheet from the fixing roller 134 per unit time decreases. For that reason, when the processable number of sheets of the image forming apparatus 110 decreases, the temperature Ts of the fixing roller 134 approaches the target temperature Ta.

In step S1150, the CPU 121 transmits, to the control apparatus 10 of the post-processing apparatus 1, an instruction to reduce the number of sheets processable by the post-processing apparatus 1 per unit time (the processable number of sheets of the post-processing apparatus 1) from 60 PPM to 50 PPM. More specifically, the CPU 121 refers to the correlation table 127b, and transmits information on the conveying speed corresponding to the inter-sheet time changed in step S1145 to the post-processing apparatus 1 via the communication I/F 117.

The control apparatus 10 of the post-processing apparatus 1 changes the sheet conveying speed from 950 mm/s to 650 mm/s on the basis of the information on the conveying speed received from the image forming apparatus 110. As a result, the power consumption in the post-processing apparatus 1 is reduced.

In step S1155, the CPU 121 refers to the correlation table 127b and reduces the processable number of sheets of the image forming apparatus 110 from 60 PPM to 53 PPM so that the processable number of sheets corresponds to the temperature difference calculated in step S1140. More specifically, the CPU 121 refers to the correlation table 127b and changes the inter-sheet time from 0.28 s to 0.45 s.

In step S1160, the CPU 121 transmits, to the control apparatus 10 of the post-processing apparatus 1, an instruction to reduce the processable number of sheets of the post-processing apparatus 1 from 60 PPM to 53 PPM. More specifically, the CPU 121 refers to the correlation table 127b, and transmits information on the conveying speed corresponding to the inter-sheet time changed in step S1145 to the post-processing apparatus 1 via the communication I/F 117.

The control apparatus 10 of the post-processing apparatus 1 changes the sheet conveying speed from 950 mm/s to 550 mm/s on the basis of the information on the conveying speed received from the image forming apparatus 110.

In step S1170, the CPU 121 determines whether or not printing corresponding to the input print instruction (input job) has ended. In a case where it is determined that the printing has ended, the CPU 121 ends the series of processing steps. Otherwise (NO in step S1170), the CPU 121 executes the processing of step S1125 again.

According to the above description, the image forming system 100 according to the first embodiment, when changing the inter-sheet time (inter-sheet distance) so that the processable number of sheets of the image forming apparatus 110 decreases, lowers the sheet conveying speed in the post-processing apparatus 1 so that the processable number of sheets of the post-processing apparatus 1 decreases. As a result, the image forming system 100 can reduce the power consumption in the post-processing apparatus 1. Therefore, the image forming system 100 according to the first embodiment can achieve lower power consumption than that of the image forming system 100X according to the related art.

In recent years, there is a growing need for an image forming system whose necessary power consumption can be supplied from one outlet (commercial power supply). The image forming system 100 according to the first embodiment can satisfy the need since the power consumption of the entire system can be suppressed.

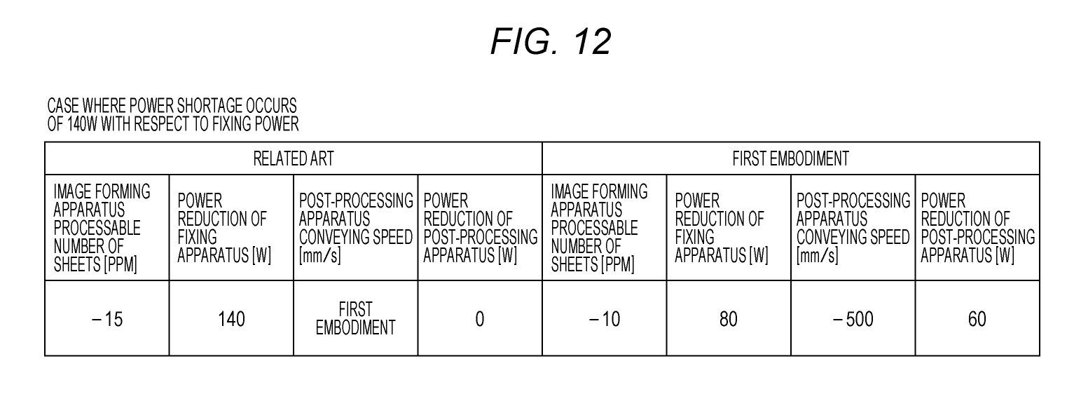

Further, the image forming system 100 is configured to supply the fixing apparatus 132 with power corresponding to a reduction in power consumption (power reduction) in the post-processing apparatus 1. Thus, the image forming system 100 can increase the processable number of sheets as compared with the image forming system 100 according to the related art. This effect will be described in more detail with reference to FIG. 12.

FIG. 12 is a diagram for comparing the image forming system 100 according to the first embodiment with the image forming system 100X according to the related art. In an aspect, it is assumed that the power is insufficient by 140 W to be supplied to the fixing apparatus in the image forming systems 100 and 100X.

In such a case, in the image forming system 100X according to the related art, control is performed such that the processable number of sheets of the image forming apparatus 110 is reduced by 15 PPM (fixing power is reduced by 140 W), whereby the image can be fixed on the sheet even when the power is insufficient by 140 W to be supplied to the fixing apparatus. At this time, the image forming system 100X does not change the sheet conveying speed in the post-processing apparatus 1X (that is, does not change the processable number of sheets of the post-processing apparatus 1).

On the other hand, the image forming system 100 according to the first embodiment reduces the processable number of sheets of the image forming apparatus 110 by 10 PPM, to reduce the fixing power of the fixing apparatus 132 by 80 W. In addition, the image forming system 100 lowers the sheet conveying speed in the post-processing apparatus 1 by 500 mm/s, to reduce the power consumption of the post-processing apparatus 1 by 60 W. As described above, in the image forming system 100 according to the first embodiment, the shortage of the power is covered by the image forming apparatus 110 and the post-processing apparatus 1. For that reason, as shown in FIG. 12, the processable number of sheets of the image forming system 100 according to the first embodiment is greater than the processable number of sheets of the image forming system 100X according to the related art.

When the processable number of sheets increases, the time is shortened during which a plurality of motors constituting the image forming system 100 is idle. For that reason, the usable period of the image forming system 100 according to the first embodiment is longer than the usable period of the image forming system 100X according to the related art. Further, due to the shortening of the idle time of the motor, the power consumption of the image forming system 100 is less than the power consumption of the image forming system 100X.

In the example of FIG. 11, the CPU 121 (control apparatus 120) sets the processable number of sheets of the image forming apparatus 110 and the processable number of sheets of the post-processing apparatus 1 to be the same value; however, these values may be different from each other in another aspect. More specifically, in a case where the inter-sheet time (inter-sheet distance) in the image forming apparatus 110 is lengthened so that the processable number of sheets of the image forming apparatus 110 is reduced, the CPU 121 may lower the sheet conveying speed in the post-processing apparatus 1 so as to decrease the processable number of sheets of the post-processing apparatus 1. This is because, thus, the image forming system 100 can reduce the power consumption at least in the post-processing apparatus 1.

In an aspect, the CPU 121 changes the sheet conveying speed in the post-processing apparatus 1 so that the processable number of sheets of the post-processing apparatus 1 becomes greater than or equal to the processable number of sheets of the image forming apparatus 110. Thus, paper jam is suppressed in the post-processing apparatus 1.

In an aspect, the CPU 121 sets the sheet conveying speed in the post-processing apparatus 1 so that the second sheet subsequent to the first sheet reaches the registration roller 35 after completion of the post-processing (punching processing, stapling processing, saddle stitching processing, or the like) of the first sheet (for example, in the case of punching processing, timing at which punching on the sheet has ended). Thus, the image forming system 100 can suppress a decrease in the processable number of sheets of the post-processing apparatus 1 (and the image forming system 100).

In addition, in the example of FIG. 11, the image forming system 100 (correlation table 127b) sets the processable number of sheets of the image forming apparatus 110 and the post-processing apparatus 1 by dividing the difference temperature between the temperature Ts of the fixing roller 134 and the target temperature Ta at intervals of 10° C. In another aspect, the correlation table 127b may set the processable number of sheets of the image forming apparatus 110 and the post-processing apparatus 1 by dividing the correlation table 127b at intervals of finer difference temperature (for example, every 2° C.). Thus, the image forming system 100 can achieve finer control of the processable number of sheets.

In yet another aspect, instead of the correlation table 127b, the image forming system 100 may store, in the HDD 127, a relational expression expressing a correlation between the difference temperature and the inter-sheet time in the image forming apparatus 110, and a relational expression expressing a correlation between the difference temperature and the sheet conveying speed in the post-processing apparatus 1. In this case, after calculating the difference temperature, the CPU 121 calculates the inter-sheet time in the image forming apparatus 110 and the sheet conveying speed in the post-processing apparatus 1 on the basis of these relational expressions. Thus, the image forming system 100 can achieve finer control of the processable number of sheets.

(An Area in Which the Sheet Conveying Speed in the Post-Processing Apparatus 1 is Changed)

In a case where the sheet conveying speed in the post-processing apparatus 1 is changed in step S1150 or S1160, the post-processing apparatus 1 is configured not to change the sheet conveying speed in all the conveying paths, but to change the sheet conveying speed in some of the conveying paths.

In an aspect, the post-processing apparatus 1 conveys the sheet at a conveying speed received from the image forming apparatus 110 (hereinafter also referred to as “specified conveying speed”) until the post-processing (for example, the stapling processing, the saddle stitching processing) is completed. The post-processing apparatus 1 ejects the sheet on which the predetermined processing is completed from the post-processing apparatus 1 at a conveying speed lower than the specified conveying speed. Thus, the post-processing apparatus 1 inhibits the sheet from being ejected from the post-processing apparatus 1 vigorously.

In another aspect, the post-processing apparatus 1 conveys the sheet at the specified conveying speed after the front end of the sheet reaches the first position of the conveying path of the post-processing apparatus 1 until the rear end of the sheet reaches the second position on the downstream side from the first position on the conveying path.

The first position is set, for example, at a position separated by a predetermined distance (for example, 10 mm) to the downstream side from the position where the registration roller 35 is arranged in the conveying path of the post-processing apparatus 1. In this case, the control apparatus 10 of the post-processing apparatus 1 determines that the front end of the sheet has reached the first position after a lapse of a predetermined time from the detection of the front end of the sheet by the sensor 26. The predetermined time is determined on the basis of the sheet conveying speed until the sheet reaches the first position and the distance from the sensor 26 to the first position.

In the case of the first position in the above example, when the front end of the sheet reaches the first position, the sheet is in contact with the conveying roller 22 and the conveying roller 23. In this state, the post-processing apparatus 1 changes the sheet conveying speed to the specified conveying speed. As described above, the specified conveying speed is higher than the sheet conveying speed in the image forming apparatus 110. For that reason, these conveying rollers 22 and 23 are configured to rotate in the conveying direction upon receipt of the force from the sheet conveyed in the conveying direction. Thus, the conveying rollers 22 and 23 do not prevent conveying of the sheet. As an example, the conveying rollers 22 and 23 have configurations such as a freewheel (one-way clutch), a torque limiter, and the like.

The second position is set, for example, at a position separated by a predetermined distance (for example, 10 mm) to the upstream side from the position where the folding roller or the ejection roller 43 arranged on the most downstream side in the conveying path of the post-processing apparatus 1 is arranged. In this case, the control apparatus 10 of the post-processing apparatus 1 determines that the front end of the sheet has passed through the first position after a lapse of a predetermined time from the detection of the rear end of the sheet by the accommodation sensor 41 or the saddle loading sensor 46. The predetermined time is determined on the basis of the specified conveying speed and the distance from the sensor to the second position.

(A Case Where Post-Processing is Not Performed)

As described above, usually, the sheet conveying speed in the post-processing apparatus 1 is set to be higher than or equal to the conveying speed in the image forming apparatus 110. The reason is to complete the post-processing of the first sheet in the post-processing apparatus 1 before the second sheet reaches the post-processing position.

However, in an aspect, there is a case where the post-processing apparatus 1 does not perform post-processing on the sheet. In such a case, the sheet conveying speed in the post-processing apparatus 1 is set to be less than or equal to the maximum conveying speed of the sheet in the image forming apparatus 110.

More specifically, when receiving an input of a print instruction (print job), the CPU 121 determines whether or not the print instruction includes an execution instruction of post-processing. In a case where the print instruction does not include the execution instruction of post-processing, the CPU 121 transmits, to the post-processing apparatus 1, information of the conveying speed less than or equal to the maximum conveying speed of the sheet in the image forming apparatus 110. The control apparatus 10 of the post-processing apparatus 1 sets the sheet conveying speed on the basis of the information received from the image forming apparatus 110. Thus, the image forming system 100 can further reduce the power consumption of the post-processing apparatus 1.

(Brief Summary)

The above disclosed technical features are summarized as follows.

The image forming system 100 is provided including: the image forming apparatus 110; and the post-processing apparatus 1 that is connectable to the image forming apparatus 110 and performs predetermined post-processing on a recording medium (sheet) on which an image is formed by the image forming apparatus 110. The image forming apparatus 110 includes: the image forming unit 130 that forms and fixes an image on a recording medium; the control apparatus 120 that controls first parameters of the image forming unit 130 relating to the processable number of sheets of the image forming unit 130, and second parameters of the post-processing apparatus 1 relating to the processable number of sheets of the post-processing apparatus 1; and the communication I/F 117 that transmits the second parameters to the post-processing apparatus 1. The post-processing apparatus 1 operates in accordance with the second parameters received from the image forming apparatus 110. When changing the first parameters to cause the processable number of sheets of the image forming apparatus 110 to decrease, the control apparatus 120 changes the second parameters to cause the processable number of sheets of the post-processing apparatus 1 to decrease.

For example, the first parameters include the inter-sheet distance, the inter-sheet time, the sheet conveying speed, and the time from the detection of the front end of the sheet to the detection of the rear end of the sheet by a sensor (for example, a registration sensor (not shown) provided inside the image forming unit 130), in the image forming apparatus 110. For example, the second parameters include the inter-sheet distance, the inter-sheet time, the sheet conveying speed, the time from the detection of the front end of the sheet to the detection of the rear end of the sheet by a sensor (for example, the registration sensor 35a), and the time required for post-processing, in the post-processing apparatus 1.

In the above example, the image forming apparatus 110 is configured to control the change of the first and second parameters. In another aspect, an external apparatus (for example, a server) enabled to communicate with the image forming apparatus 110 may be configured to control the change of the first and second parameters. In such a case, the image forming system 100 transmits operation information (for example, information representing printing operation currently being executed, a measurement result of the temperature sensor 136, and the like) to the external apparatus. The external apparatus determines the first and second parameters on the basis of the received operation information, and transmits the determined information to the image forming system 100.

### Second Embodiment

An image forming system according to a second embodiment changes the processable number of sheets (productivity) of the image forming apparatus depending on an amount of heat (hereinafter also referred to as “heat storage amount”) stored in the fixing apparatus (fixing roller). The reason is that a degree of drop in the temperature Ts of the fixing roller in a case where the power supplied to the fixing apparatus is reduced depends on the heat storage amount of the fixing apparatus. More specifically, as the heat storage amount of the fixing apparatus is larger, the degree of drop is smaller in the temperature Ts of the fixing roller in the case where the power supplied to the fixing apparatus is reduced. For that reason, in a case where the heat storage amount of the fixing apparatus is large, the fixing apparatus can apply a sufficient amount of heat that fixes the image to the sheet without greatly reducing the processable number of sheets of the image forming apparatus. Hereinafter, a configuration and control will be described of the image forming system according to the second embodiment.

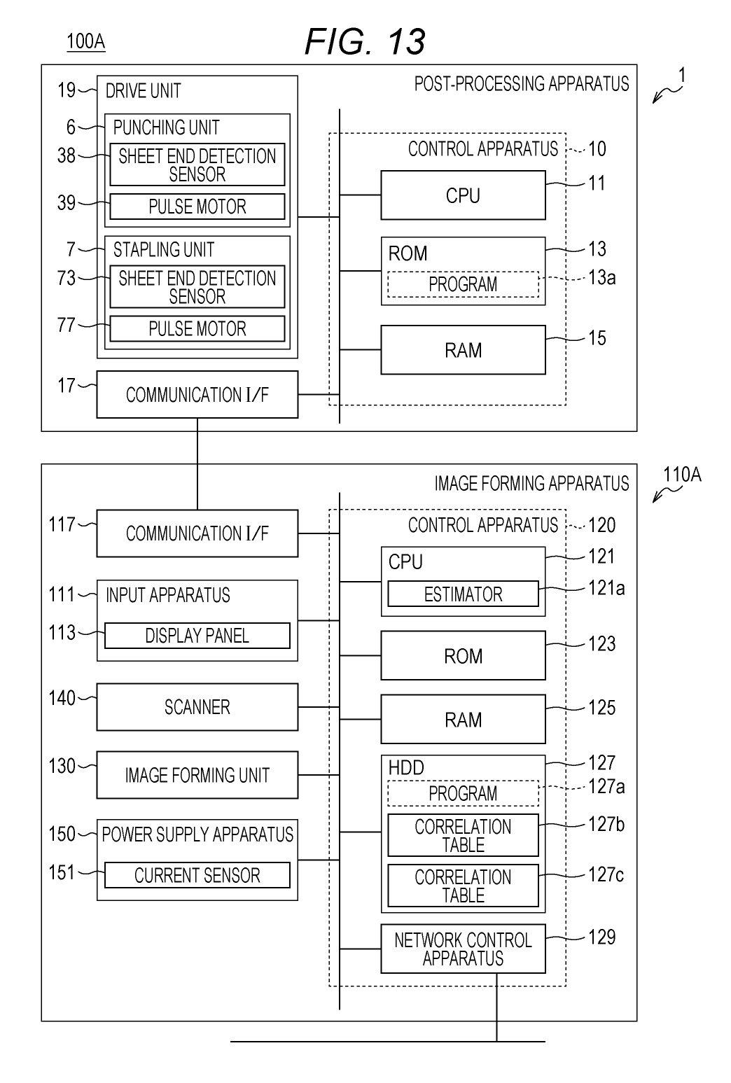

FIG. 13 is a diagram for explaining a configuration of an image forming system 100A according to the second embodiment. The configuration of the image forming system 100A according to the second embodiment is substantially the same as that of the image forming system 100 according to the above-described first embodiment. For that reason, only different constituents will be described below.

In an aspect, the CPU 121 of an image forming apparatus 110A reads and executes the program 127a, to function as an estimator 121a.

The estimator 121a estimates the heat storage amount of the fixing roller. As an example, the estimator 121a estimates the heat storage amount on the basis of the energization (ON) time of a heater (not shown) that heats the fixing roller 134. This is because, usually, the longer the energization time of the heater is, the larger the heat storage amount becomes.

As another example, the estimator 121a estimates the heat storage amount on the basis of a measurement result of a temperature sensor (a temperature sensor different from the temperature sensor 136 that measures the surface temperature of the fixing roller 134) (not shown) that measures temperature of the inside of the fixing roller (for example, the center of the rotating shaft).

The HDD 127 further stores a correlation table 127c, in addition to the correlation table 127b. The correlation table 127c is a table used in a case where the heat storage amount of the fixing roller 134 is greater than or equal to a predetermined amount of heat. In one aspect, in a case where the energization time of the heater that heats the fixing roller 134 is longer than or equal to a predetermined time (for example, 30 minutes), the CPU 121 (estimator 121a) determines that the heat storage amount of the fixing roller 134 is greater than or equal to the predetermined amount of heat. In another aspect, in a case where the temperature inside the fixing roller 134 is higher than or equal to a predetermined temperature, the CPU 121 determines that the heat storage amount of the fixing roller 134 is greater than or equal to the predetermined amount of heat.

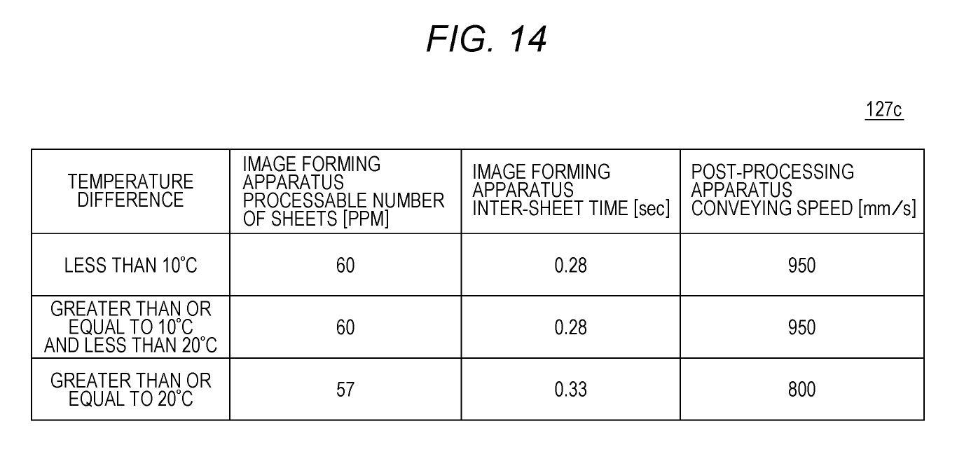

FIG. 14 is a diagram showing an example of the data structure of the correlation table 127c. In the correlation table 127c, as compared with the correlation table 127b shown in FIG. 9, the processable number of sheets is greater of the image forming apparatus with respect to the temperature difference, and the sheet conveying speed is higher in the post-processing apparatus 1. For example, in a case where the temperature difference is greater than or equal to 10° C. and less than 20° C., the processable number of sheets of the image forming apparatus set in the correlation table 127c is 60 PPM (that is, not changed from the number of processable sheets of when the temperature difference is less than 10° C.), whereas the processable number of sheets of the image forming apparatus set in the correlation table 127b is 53 PPM.

According to the above description, the image forming system 100A according to the second embodiment uses the correlation table 127c in a case where the heat storage amount of the fixing roller 134 is large, whereby higher productivity (greater processable number of sheets) can be achieved than that of the image forming system 100 according to the first embodiment. As a result, the image forming system 100A according to the second embodiment can reduce the idle time of the motor, so that lower power consumption can be achieved than that of the image forming system 100 according to the first embodiment.

### Third Embodiment

An image forming system according to a third embodiment changes the processable number of sheets of the image forming apparatus depending on the temperature of the environment (hereinafter also referred to as “environmental temperature”) in which the image forming apparatus is installed. The reason is that the degree of drop in the temperature Ts of the fixing roller in the case where the power supplied to the fixing apparatus is reduced depends on the environmental temperature. More specifically, in a case where the environmental temperature is low, the degree of drop is large in the temperature Ts of the fixing roller with respect to a reduction amount of the power supplied to the fixing apparatus. For that reason, in the case where the environmental temperature is low, the image forming system according to the third embodiment greatly reduces the processable number of sheets of the image forming apparatus (and the post-processing apparatus), to secure the amount of heat of the fixing roller necessary for fixing the image on the sheet. Hereinafter, a configuration and control will be described of the image forming system according to the third embodiment.

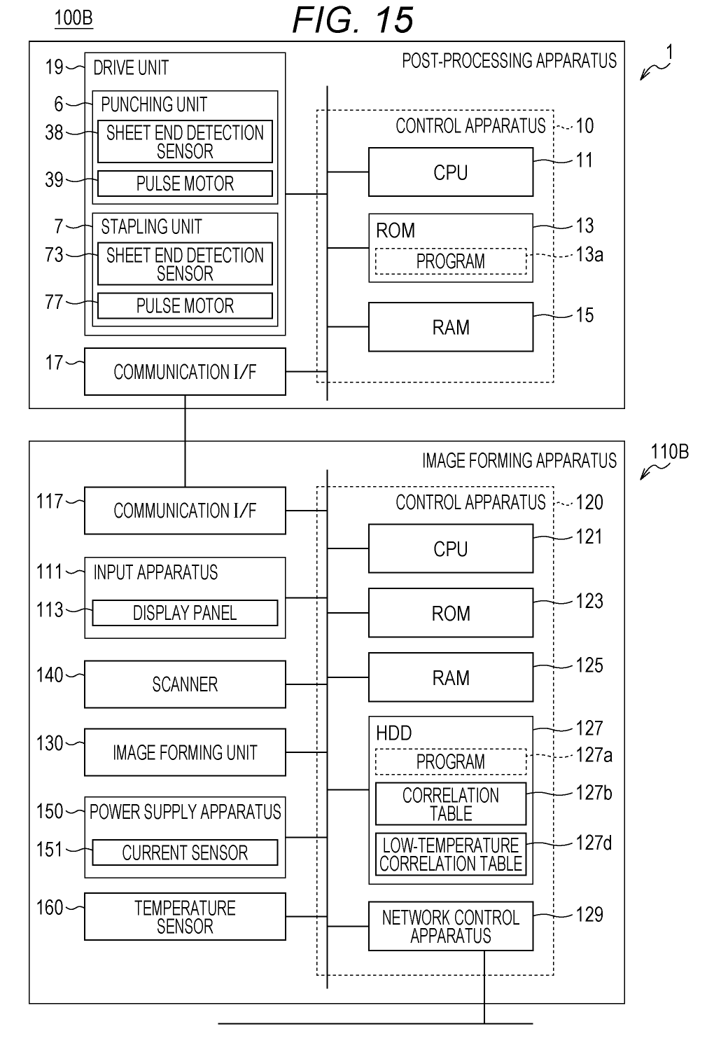

FIG. 15 is a diagram for explaining a configuration of an image forming system 100B according to the third embodiment. The configuration of the image forming system 100B according to the third embodiment is substantially the same as that of the image forming system 100 according to the above-described first embodiment. For that reason, only different constituents will be described below.

In an aspect, an image forming apparatus 110B further includes a temperature sensor 160. The temperature sensor 160 measures a temperature of an environment in which the image forming apparatus 110B is installed. The temperature sensor 160 may measure a temperature inside the casing of the image forming apparatus 110B, or may measure a temperature outside the casing of the image forming apparatus 110B. The temperature sensor 160 outputs a measurement result to the control apparatus 120.

The HDD 127 further stores a low-temperature correlation table 127d, in addition to the correlation table 127b. The low-temperature correlation table 127d is a table used in a case where the environmental temperature is lower than or equal to a predetermined temperature (for example, 10° C.).

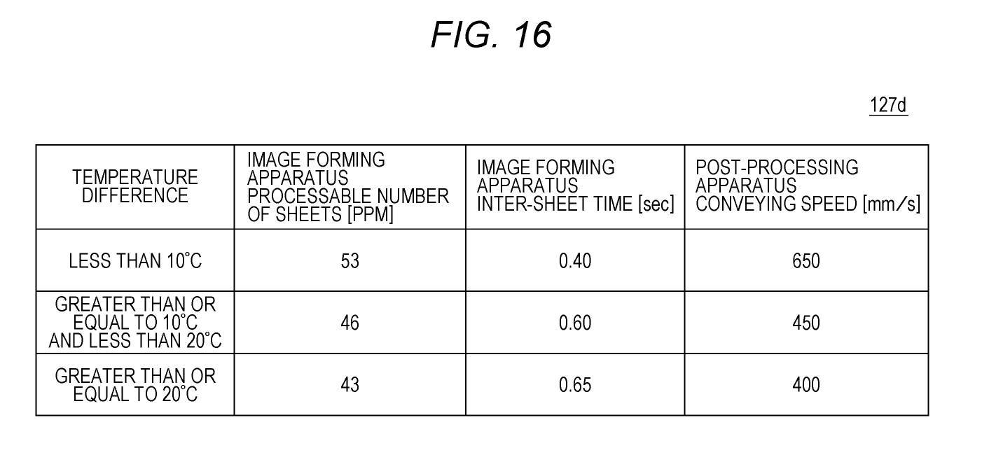

FIG. 16 is a diagram showing an example of the data structure of the low-temperature correlation table 127d. In the low-temperature correlation table 127d, as compared with the correlation table 127b shown in FIG. 9, the processable number of sheets is smaller of the image forming apparatus with respect to the temperature difference, and the sheet conveying speed is lower in the post-processing apparatus 1. For example, in a case where the temperature difference is greater than or equal to 10° C. and less than 20° C., the processable number of sheets of the image forming apparatus set in the low-temperature correlation table 127d is 46 PPM, whereas the processable number of sheets of the image forming apparatus set in the correlation table 127b is 53 PPM.

According to the above, the image forming system 100B according to the third embodiment uses the low-temperature correlation table 127d in the case where the environmental temperature is low, whereby poor fixing of the image on the sheet can be suppressed.

In another aspect, the image forming apparatus 110B may store a high-temperature correlation table in the HDD 127. Data items held in the high-temperature correlation table are the same as data items held in the correlation table 127b. In the high-temperature correlation table, as compared with the correlation table 127b, the processable number of sheets is greater of the image forming apparatus with respect to the temperature difference, and the sheet conveying speed is higher in the post-processing apparatus 1. In a case where the environmental temperature is higher than or equal to a predetermined temperature (for example, 30° C.), the CPU 121 uses the high-temperature correlation table to set the processable number of sheets of the image forming apparatus 110B and the conveying speed of the post-processing apparatus 1. Thus, the image forming system 100B according to the third embodiment can achieve higher productivity (greater processable number of sheets) than that of the image forming system 100 according to the first embodiment. As a result, the image forming system 100B according to the third embodiment can reduce the idle time of the motor, so that lower power consumption can be achieved than that of the image forming system 100 according to the first embodiment.

The above-described various types of processing are achieved by the CPU 121 (control apparatus 120) or the CPU 11 (control apparatus 10), but the present invention is not limited thereto. These various functions can be implemented by at least one semiconductor integrated circuit such as a processor, at least one application specific integrated circuit (ASIC), at least one digital signal processor (DSP), at least one field programmable gate array (FPGA), and/or another circuit having arithmetic functions.

These circuits can perform the various types of processing described above by reading one or more instructions from at least one tangible and readable medium.

Such a medium takes the form of a magnetic medium (for example, a hard disk), an optical medium (for example, a compact disc (CD), a DVD), a memory of any type of a volatile memory, nonvolatile memory, or the like, but is not limited thereto.

Although embodiments of the present invention have been described and illustrated in detail, the disclosed embodiments are made for purposes of illustration and example only and not limitation. The scope of the present invention should be interpreted by terms of the appended claims. It is intended that meanings equivalent to the claims and all modifications within the scope are included.

What is claimed is:

1. An image forming system comprising:
an image forming apparatus; and
a post-processing apparatus that is connectable to the image forming apparatus and performs predetermined processing on a recording medium on which an image is formed by the image forming apparatus, wherein
the image forming apparatus includes
an image forming unit that forms and fixes an image on a recording medium,
a hardware processor that controls a first parameter of the image forming unit, the first parameter relating to a first processable number of sheets that is a number of sheets of the recording medium processable by the image forming unit per unit time, and a second parameter of the post-processing apparatus, the second parameter relating to a second processable number of sheets that is a number of sheets of the recording medium processable by the post-processing apparatus per the unit time, and
a communication interface that transmits the second parameter to the post-processing apparatus,
the post-processing apparatus operates in accordance with the second parameter received from the image forming apparatus, and
the hardware processor changes the second parameter to cause the second processable number of sheets to decrease, when changing the first parameter to cause the first processable number of sheets to decrease.

2. The image forming system according to claim 1, wherein
the hardware processor changes the second parameter to cause the second processable number of sheets after changing the second parameter to be greater than or equal to the first processable number of sheets after changing the first parameter, when changing the first parameter to cause the first processable number of sheets to decrease.

3. The image forming system according to claim 1, wherein
the first parameter includes an interval between the recording media in the image forming unit.

4. The image forming system according to claim 1, wherein
the second parameter includes a conveying speed of the recording medium in the post-processing apparatus.

5. The image forming system according to claim 1, wherein
the first parameter includes an interval between the recording media in the image forming unit,
the second parameter includes a conveying speed of the recording medium in the post-processing apparatus,
the image forming apparatus further includes a storage apparatus that stores a table representing a correspondence between the interval between the recording media in the image forming unit and the conveying speed of the recording medium in the post-processing apparatus, and
the hardware processor refers to the table to change the conveying speed of the recording medium in the post-processing apparatus, when changing the interval between the recording media in the image forming unit.

6. The image forming system according to claim 4, wherein
the post-processing apparatus includes a registration roller that is arranged on an upstream side of a position where the predetermined processing is performed on a conveying path of the recording medium and adjusts conveying timing of the recording medium, and
the hardware processor changes the conveying speed of the recording medium in the post-processing apparatus to cause a second recording medium following a first recording medium to reach the registration roller after completion of the predetermined processing on the first recording medium.

7. The image forming system according to claim 4, wherein
the hardware processor changes a conveying speed of the recording medium in the post-processing apparatus, the conveying speed being a speed until completion of the predetermined processing on the recording medium.

8. The image forming system according to claim 7, wherein
the post-processing apparatus ejects the recording medium on which the predetermined processing is completed from the post-processing apparatus at a conveying speed lower than the conveying speed until completion of the predetermined processing of the recording medium.

9. The image forming system according to claim 4, wherein
the hardware processor changes the conveying speed of the recording medium in the post-processing apparatus after a front end of the recording medium reaches a first position of the conveying path of the recording medium in the post-processing apparatus until a rear end of the recording medium reaches a second position on a downstream side from the first position.

10. The image forming system according to claim 9, wherein
the post-processing apparatus includes a registration roller that is arranged on an upstream side of a position where the predetermined processing is performed on a conveying path of the recording medium and adjusts conveying timing of the recording medium, and
the first position is a position separated by a predetermined distance to the downstream side from a position where the registration roller is arranged on the conveying path, and
the second position is a position separated by a predetermined distance from a position where a conveying roller arranged on a most downstream side of the conveying path is arranged.

11. The image forming system according to claim 9, wherein
a conveying roller in contact with the recording medium when the front end of the recording medium reaches the first position receives force from the recording medium conveyed in a conveying direction and rotates in the conveying direction.

12. The image forming system according to claim 4, wherein
the hardware processor changes the conveying speed of the recording medium in the post-processing apparatus to less than or equal to a conveying speed of the recording medium in the image forming apparatus when the post-processing apparatus does not execute the predetermined processing.

13. The image forming system according to claim 4, wherein
the image forming unit includes a fixing apparatus that fixes an image on the recording medium, and
the hardware processor
includes an estimator that estimates a heat storage amount of the fixing apparatus, and
changes the conveying speed of the recording medium in the post-processing apparatus on the basis of the heat storage amount estimated.

14. The image forming system according to claim 4, wherein
the image forming apparatus further includes a temperature sensor that measures a temperature, and
the hardware processor changes the conveying speed of the recording medium in the post-processing apparatus on the basis of the temperature measured.

15. The image forming system according to claim 1, wherein
the image forming unit includes a fixing roller that fixes an image on the recording medium,
the image forming apparatus further includes a fixing temperature sensor that measures a temperature of the fixing roller, and
when the temperature of the fixing roller measured by the fixing temperature sensor is less than a predetermined temperature, the hardware processor changes the first parameter to cause the first processable number of sheets to decrease on the basis of a difference between the predetermined temperature and the temperature of the fixing roller.

16. An image forming apparatus connectable to a post-processing apparatus, the image forming apparatus comprising:
an image forming unit that forms and fixes an image on a recording medium;
an ejection port that outputs the recording medium output by the image forming unit to the post-processing apparatus;
a hardware processor that controls a first parameter of the image forming unit, the first parameter relating to a first processable number of sheets that is a number of sheets of the recording medium processable by the image forming unit per unit time, and a second parameter of the post-processing apparatus, the second parameter relating to a second processable number of sheets that is a number of sheets of the recording medium processable by the post-processing apparatus per the unit time; and
a communication interface that transmits the second parameter to the post-processing apparatus, wherein
the hardware processor changes the second parameter to cause the second processable number of sheets to decrease, when changing the first parameter to cause the first processable number of sheets to decrease.

17. A hardware processor of an image forming system,
the image forming system including
an image forming apparatus that forms and fixes an image on a recording medium, and
a post-processing apparatus that is connectable to the image forming apparatus and performs predetermined processing on a recording medium on which an image is formed by the image forming apparatus,
the hardware processor
being enabled to control a first parameter of the image forming apparatus, the first parameter relating to a first processable number of sheets that is a number of sheets of the recording medium processable by the image forming apparatus per unit time, and a second parameter of the post-processing apparatus, the second parameter relating to a second processable number of sheets that is a number of sheets of the recording medium processable by the post-processing apparatus per the unit time, and
changing the second parameter to cause the second processable number of sheets to decrease, when changing the first parameter to cause the first processable number of sheets to decrease.

18. A control method of an image forming system including an image forming apparatus and a post-processing apparatus connectable to the image forming apparatus, the control method comprising:
forming an image on a recording medium;
fixing the image formed to the recording medium;
changing a first parameter of the image forming apparatus, the first parameter relating to a first processable number of sheets that is a number of sheets of the recording medium processable by the image forming apparatus per unit time; and
changing a second parameter of the post-processing apparatus, the second parameter relating to a second processable number of sheets that is a number of sheets of the recording medium processable by the post-processing apparatus per the unit time, to cause the second processable number of sheets to decrease, when the first parameter is changed to cause the first processable number of sheets to decrease.

19. A non-transitory recording medium storing a computer readable program executed by a computer of an image forming apparatus connectable to a post-processing apparatus, the program causing the computer to execute:
forming an image on a recording medium;
fixing the image formed to the recording medium;
changing a first parameter of the image forming apparatus, the first parameter relating to a first processable number of sheets that is a number of sheets of the recording medium processable by the image forming apparatus per unit time;
changing a second parameter of the post-processing apparatus, the second parameter relating to a second processable number of sheets that is a number of sheets of the recording medium processable by the post-processing apparatus per the unit time, to cause the second processable number of sheets to decrease, when the first parameter is changed to cause the first processable number of sheets to decrease; and
transmitting the second parameter to the post-processing apparatus.
